(19) United States
(12) Patent Application Publication
(10) Pub. No.: US 2007/0100044 A1
(43) Pub. Date: May 3, 2007

(54) Pvc-pcc nanocomposites resin composition with superior impact strengths and method for preparing the same

(75) Inventors: Hee-Joo Jeon, Daejeon (KR); Kwang-Min Park, Daegu (KR); Se-Hyun Shin, Daejeon (KR); Sung-Woo Kim, Daegu (KR)

Correspondence Address: CANTOR COLBURN, LLP, 55 GRIFFIN ROAD SOUTH, BLOOMFIELD, CT, 06002, US

(73) Assignee: LG CHEM, LTD., SEOUL (KR)

(21) Appl. No.: 10/579,250

(22) PCT Filed: Nov. 15, 2004
(86) PCT No.: PCT/KR04/02952

§ 371 Date: May 12, 2006

(30) Foreign Application Priority Data
Nov. 14, 2003 (KR) 10-2003-0080415

(51) Int. Cl. C08K 5/00

(52) U.S. Cl. 524/284; 524/425; 524/567; 524/502

(57) ABSTRACT

The present invention relates to a PVC based nanocomposite resin composition with superior impact strength and a method for preparing the same. The method according to the present invention comprises the steps of: adding nano calcium carbonate and a lipophilic dispersing agent to a vinyl chloride monomer; adding the resultant mixture system to an aqueous solution system comprising deionized water, a suspension stabilizer and a polymerization initiator to prepare a suspension system and performing polymerization at an elevated temperature to prepare a PVC based nanocomposite resin composition; and processing the PVC based nanocomposite resin composition with at least one impact modifier selected from the group consisting of a methyl methacrylate-butadiene-styrene copolymer, an acrylic impact modifier and a chlorinated polyethylene. Preferably, the nano calcium carbonate is uniformly distributed in the vinyl chloride particles, so that improvement in impact strength and reduction of impact modifier required for processing the resin can be attained.

### TECHNICAL FIELD

The present invention relates to a nanocomposite resin composition and a method for preparing the same. More particularly, the present invention relates to a PVC based nanocomposite resin composition with superior impact strength, which is prepared by uniformly dispersing nano calcium carbonate in a vinyl chloride monomer, dispersing the mixture system in water to obtain an suspension system and polymerizing it at an elevated temperature, and a method for preparing the same.

### BACKGROUND ART

In general, PVC resins are utilized in the soft and the rigid applications. Soft applications include wallpaper, floorings, artificial leather, toys, disposable polygloves, etc., where PVC resins are used in the form of paste in combination with a lot of plasticizer. Paste PVC resins are manufactured by emulsion polymerization or MSP (microsuspension seeded Polymerization). The rigid applications including pipes, window frames and hard sheets adopt extrusion, calendaring or injection process. PVC resins for rigid applications are mostly manufactured by suspension polymerization. In the processing of PVC, additives are typically used altogether to enhance properties and to secure the stability of the resins while processing; impact modifier, heat stabilizer, processing aid, pigment, and inorganic filler to name a few. For example, PVC window profile compound includes 6-10 parts by weight of an impact modifier such as methyl methacrylate-butadiene-styrene (MBS) copolymer, acrylic impact modifier, chlorinated polyethylene (CPE), per 100 parts by weight of a PVC resin to enhance the impact strength of the final article. However, these impact modifiers are expensive compared to PVC resin.

PCC (precipitated calcium carbonate) having a particle size of about 0.07 micron (70 nm) was reported to have an impact modification effect (J. A. Radosta. “Low Temperature and Ambient Impact Modification of Polymers with Surface Treated Calcium Carbonate” SPE ANTEC, New Orleans, May 7-10, 1979). According to this report, a superior impact modification effect is obtained for an extrusion article of a mixture of at least 10 parts by weight of PCC and 100 parts by weight of a PVC resin. In this case, the extrusion article was prepared by several cycles of processing including mixing, roll-mill press, crushing and extrusion of the PCC/PVC mixture to ensure the fine dispersion of the PCC in the polymer matrix. Nano PCC, which is finely dispersed in a polymer medium, is suggested to disperse impact energy into the polymer medium due to its large specific surface area. For nano PCC to have an impact modification effect, the primary PCC particle should have a size of 100 nm or less to maximize the surface area, and the nano particles should be dispersed in the polymer medium as close as the primary particle. Nano dispersion of PCC in polymer matrix is difficult to achieve with the general extrusion processing. The multi-step processing proposed in the report, which is difficult to apply to industrial productions, adopts external physical force to finely disperse the PCC in the polymer medium.

### DISCLOSURE OF INVENTION

In the present invention, a uniform and fine dispersion is obtained by dispersing nano PCC in a vinyl chloride monomer and subsequent suspension polymerization.

It is an aspect of the present invention to provide a PVC-based nanocomposite resin composition with superior impact strength, which is prepared by uniformly dispersing nano calcium carbonate in a vinyl chloride monomer, dispersing the mixture system in water to obtain an suspension system and polymerizing the suspension system at an elevated temperature, and a method for preparing the same.

The aspect and other aspects can be attained by the present invention.

The present invention provides a nano calcium carbonate/vinyl chloride monomer dispersion comprising a vinyl chloride monomer, nano calcium carbonate and a lipophilic dispersing agent.

The nano calcium carbonate/vinyl chloride monomer dispersion may further comprise a polymerization initiator.

The polymerization initiator may be at least one polymerization initiator selected from the group consisting of diacyl peroxide, peroxy ester, peroxy dicarbonate, etc.

The nano calcium carbonate may be comprised in 1-30 parts by weight, the lipophilic dispersing agent may be comprised in 0.01-10 parts by weight and the polymerization initiator may be comprised in 0.01-5 parts by weight per 100 parts by weight of the vinyl chloride monomer.

The lipophilic dispersing agent may be a monomer or polymer having a molecular weight of 40-100,000 containing a phosphoric acid, a carboxylic acid or a salt thereof.

The salts of the phosphoric acid or the carboxylic acid may have an organic side chain selected from the group consisting of sodium, ammonium, primary, secondary, tertiary or quaternary alkyl ammonium, C₁-C₃₀ hydrocarbon, a homopolymer selected from the group consisting of polyolefin, polyether, polymethacrylate, polyacrylate, polyester and polyurethane, and copolymers thereof.

The lipophilic polymer type dispersing agent may have a homopolymer chain selected form the group consisting of polyolefin, polyether, polymethacrylate, polyacrylate, polyacetate, polyester and polyurethane or copolymers thereof as a main chain.

The present invention also provides a PVC based nanocomposite resin composition prepared using the nano calcium carbonate/vinyl chloride monomer dispersion.

The nano calcium carbonate may have a particle size of at most 500 nm:

The surface of the nano calcium carbonate may be modified with a metal salt of an organic carboxylic acid.

The nano calcium carbonate/vinyl chloride monomer dispersion is the same as described above.

The present invention also provides a method for preparing a PVC based nanocomposite resin composition comprising the steps of (a) adding nano calcium carbonate and a lipophilic dispersing agent to a vinyl chloride monomer to disperse them; (b) adding the resultant mixture system to an aqueous solution system comprising deionized water, a suspension stabilizer and a polymerization initiator to prepare a suspension system and performing polymerization at an elevated temperature to prepare a PVC based nanocomposite resin composition; (c) processing the PVC based nanocomposite resin including an impact modifier to produce extruded articles with a superior impact strength.

The polymerization at an elevated temperature may be performed at 50-65° C.

In preparing the PVC based nanocomposite resin composition, the polymerization temperature may be determined so that the degree of polymerization becomes 700-1300. The polymerization initiator may be added in the step (a), instead of the step (b).

The nano calcium carbonate and the lipophilic dispersing agent of the step (a) may be used in 1-30 parts by weight and 0.01-10 parts by weight, respectively, per 100 parts by weight of the vinyl chloride monomer. The deionized water, the suspension stabilizer and the polymerization initiator of the step (b) may be used in 100-300 parts by weight, 0.01-5 parts by weight and 0.01-5 parts by weight, respectively, per 100 parts by weight of the vinyl chloride monomer. The impact modifier of the step (c) may be at least one selected from the group consisting of a methyl methacrylate-butadiene-styrene copolymer, an acrylic impact modifier and a chlorinated polyethylene and may be used in 1-10 parts by weight per 100 parts by weight of the PVC based nanocomposite resin composition.

The nano calcium carbonate may have a particle size of at most 500 nm.

The lipophilic dispersing agent may be a monomer or polymer compound having a molecular weight of 40-100,000 containing a phosphoric acid, a carboxylic acid or a salt thereof.

The salts of the phosphoric acid or the carboxylic acid may have an organic side chain selected from the group consisting of sodium, ammonium, primary, secondary, tertiary or quaternary alkyl ammonium, C₁-C₃₀ hydrocarbon, a homopolymer selected from the group consisting of polyolefin, polyether, polymethacrylate, polyacrylate, polyester and polyurethane, and copolymers thereof.

The lipophilic polymer type dispersing agent may have a homopolymer selected form the group consisting of polyolefin, polyether, polymethacrylate, polyacrylate, polyacetate, polyester and polyurethane or copolymers thereof as a main chain.

The suspension stabilizer may be at least one selected from the group consisting of vinyl acetate, cellulose and gelatin.

For the suspension stabilizer, a primary suspension stabilizer comprising at least one of a polyvinyl acetate having a degree of polymerization of 500-3,000, which has been hydrolyzed to 70-98 mol %, and a modified cellulose having a degree of substitution of 1.0-3.0 and a degree of polymerization of 50-2,000; a secondary suspension stabilizer comprising a polyvinyl acetate having a degree of polymerization of 500-3000, which has been hydrolyzed to 10-60 mol %, etc. may be used.

Hereunder is given a more detailed description of the present invention.

The method for preparing a PVC based nanocomposite according to the present invention comprises the steps of dispersing nano calcium carbonate in a vinyl chloride monomer, adding the resultant mixture system to an aqueous solution system comprising water, a suspension stabilizer and a polymerization initiator to prepare a suspension, polymerizing the vinyl chloride monomer at an elevated temperature to prepare a PVC/nano calcium carbonate composite resin and processing the resultant composite resin.

In another embodiment of the present invention, the polymerization initiator may be added in the step of preparing the nano calcium carbonate/vinyl chloride monomer mixture system.

1. Dispersion of Nano Calcium Carbonate

The step of adding nano calcium carbonate and a lipophilic dispersing agent to a vinyl chloride monomer to disperse them is described in detail.

In the present invention, a precipitated calcium carbonate (PCC) having a particle size smaller than 1 μm, preferably 40-70 nm, is used. Preferably, the nano calcium carbonate is used in 1-30 parts by weight per 100 parts by weight of the vinyl chloride monomer, considering the polymerization stability of the suspension system, the extrusion processing condition and the physical properties of the final product.

Because the surface of the nano calcium carbonate is hydrophilic, it should be treated with a metal salt of an organic carboxylic acid such as fatty acid, resin acid, etc. In the present invention, the surface of the nano calcium carbonate is modified with fatty acid to wet the vinyl chloride monomer. However, an additional dispersing agent is required to obtain an ultrafine (sub-micron size) dispersion of PCC in vinyl chloride.

The lipophilic dispersing agent is a monomer dispersing agent or a polymer dispersing agent having carboxylic acid, phosphoric acid or a salt thereof, so that it is soluble in an organic phase and compatible with the surface of the nano calcium carbonate. More preferably, it has a chemical structure compatible with a PVC resin.

The salt of phosphoric acid or carboxylic acid has sodium, ammonium, a primary, secondary, tertiary or quaternary alkyl ammonium salt, C₁-C₃₀ hydrocarbon, a homopolymer selected from the group consisting of polyolefin, polyether, polymethacrylate, polyacrylate, polyacetate, polyester and polyurethane or a copolymer thereof as side chain.

Typically, the main chain of the lipophilic dispersing agent may be an oligomer or a polymer such as polyether like poly(ethylene oxide) and poly(propylene oxide); polyacrylate like poly(methyl methacrylate), poly(n-hexyl methacrylate), poly(n-propyl acrylate) and (poly(n-butyl acrylate); polylactone like poly(e-caprolactone), poly(β-propiolactone), poly (valerolactone), etc.; polyester, etc. Also, a polymer with a strong polarity so as to be compatible with a PVC resin or polymers with PVC-friendly functional groups, such as polyurethane and poly(vinyl acetate), may be used as the main chain of the lipophilic dispersing agent. The lipophilic dispersing agent may adopt a homopolymer, a copolymer of the above polymer components or a copolymer comprising other polymer components.

A typical structure of the dispersing agent is illustrated in Formulas 1 and 2 below:

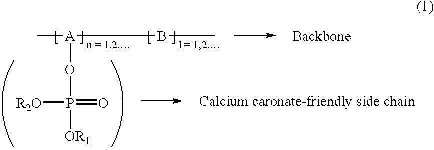

where each of A and B of the backbone of the polymer is a homopolymer or a copolymer selected from the group consisting of polyether, polyolefin, polymethacrylate, polyacrylate, polyacetate, polyester and polyurethane; each of R₁ and R₂ in the calcium carbonate-friendly side chain is hydrogen, C₁-C₃₀ hydrocarbon or a homopolymer or a copolymer selected from the group consisting of polyether, polymethacrylate, polyacrylate, polyacetate, polyester and polyurethane; n and 1 are integers.

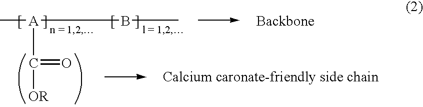

where each of A and B of the backbone of the polymer is a homopolymer or a copolymer selected from the group consisting of polyether, polyolefin, polymethacrylate, polyacrylate, polyacetate, polyester and polyurethane; R of the calcium carbonate-friendly side chain is hydrogen, sodium, ammonium, primary, secondary, tertiary or quaternary alkyl ammonium, C₁-C₃₀ hydrocarbon or a homopolymer or a copolymer selected from the group consisting of polyether, polymethacrylate, polyacrylate, polyacetate, polyester and polyurethane; and n and l are integers.

The dispersing agent has molecular weight ranging from 40 to 100,000, preferably ranging from 200 to 100,000. Also preferably, l and n are integers equal to or larger than 1. For example, if A is a homopolymer of polyethylene oxide having a molecular weight of 300 and a phosphoric acid unit is present in the terminal of the molecule, then each of m and n is 1. Also, if an acid unit is present in the side chain of the polymer, the proportion of each copolymer unit may be expressed by m and n. Here, m represents the proportion of the phosphoric acid or carboxylic acid and n represents the proportion of the polymer unit.

Typical examples of adsorption groups that enable effective dispersion in an organic phase by electronic and steric interaction with the surface of the nano calcium carbonate are carboxylic acid and phosphoric acid. Organic salts of these acids can also be utilized. Besides, any acid having affinity to the surface of the nano calcium carbonate, which is coordinated by a cation, may be the adsorption group of the lipophilic dispersing agent.

Preferably, the lipophilic dispersing agent is used in 0.01-10 parts by weight per 100 parts by weight of the nano calcium carbonate. If the content of the lipophilic dispersing agent is below 0.01 parts by weight, the calcium carbonate may be precipitated on the vinyl chloride monomer. Otherwise, if it exceeds 10 parts by weight, the dispersing agent may remain on the surface of the final product to cause foaming, decrease of heat stability, discoloring, etc.

2. Polymerization of Nano Calcium Carbonate/Vinyl Chloride Composite Resin

The step of dispersing the vinyl chloride monomer mixture system, in which the nano calcium carbonate has been dispersed, in water to prepare a suspension and polymerizing it to prepare a PVC/nano calcium carbonate composite is described in detail.

If deionized water containing a suspension stabilizer and a polymerization initiator is mixed with the nano calcium carbonate/vinyl chloride monomer dispersion system and stirred, a liquid drop of vinyl chloride having a size of 10-50 μm is formed in water. The deionized water is used in 100-300 parts by weight, preferably in 150 parts by weight, per 100 parts by weight of the vinyl chloride monomer. The suspension stabilizer may be vinyl acetate, cellulose, gelatin, etc. A polyvinyl acetate having a degree of polymerization of 500-3,000, which has been hydrolyzed to 70-98 mol %, and a modified cellulose having a degree of substitution of about 1.0-3.0 and a degree of polymerization about 50-2,000 are used as the primary suspension stabilizer. For the secondary suspension stabilizer, a polyvinyl acetate which has been hydrolyzed to 10-60 mol % may be used. In addition, a pH controller, an antioxidant, a scaling inhibitor, etc. may be added in the polymerization step to improve whiteness, weather resistance, etc. of the resin.

3. Preparation of PVC Based Nanocomposite Resin

4-6 parts by weight of a composite stabilizer comprising a heat stabilizer and a lubricant and 1-10 parts by weight of a methyl methacrylate-butadiene-styrene (MBS) copolymer, an acrylic impact modifier (AIM) or a chlorinated polyethylene (CPE) are added to 100 parts by weight of the nano calcium carbonate/vinyl chloride composite resin composition. The mixture is mixed at 90-120° C. for 5-30 minutes and a PVC based nanocomposite resin composition is prepared using a HAAKE extruder. A planar sample having a thickness of 3 mm is prepared using the resultant composition. The conditions of mixing and extrusion may be different depending on the equipments.

The PVC based nanocomposite resin composition may be further processed by adding a heat stabilizer, a lubricant, a processing aid, an antioxidant, etc., if required.

### BRIEF DESCRIPTION OF DRAWINGS

FIG. 1 is the scanning electron micrograph (SEM) of the cross-section of the PVC based nanocomposite resin composition prepared according to the present invention.

### MODES FOR CARRYING OUT THE INVENTION

Hereinafter, the present invention is described more specifically through examples. But the present invention is not limited to or by them.

### EXAMPLE 1

A PVC/nano calcium carbonate composite was prepared as follows.

(1) Dispersion of Nano Calcium Carbonate on Vinyl Chloride Monomer

9 parts by weight of nano calcium carbonate and 0.45 parts by weight of a lipophilic dispersing agent (BYK102®, BYK Chemie) were added to a 1,000-L, high-pressure stirring tank. The tank was evacuated. 100 parts by weight (300 kg) of a vinyl chloride monomer was added to the tank and stirring was performed for 90 minutes to obtain a stable dispersion.

(2) Polymerization of PVC/Nano Calcium Carbonate Composite

0.055 part by weight of a primary and a secondary suspension stabilizers comprising 150 parts by weight of deionized water, PVA and cellulose and each 0.03 part by weight of t-butyl peroxyneodecanate and di-2-ethylhyxyl peroxydicarbonate were added to a reactor. The mixture system of (1) was transferred and polymerization was performed at 58° C. after stirring for 90 minutes. When the pressure difference of the reactor reached 1 kgf/cm², the reactor was cooled down and the remaining vinyl chloride monomer was removed. The resultant product was dried to obtain a PVC/nano calcium carbonate composite resin.

(3) Processing of PVC/Nano Calcium Carbonate Composite

6 parts by weight of a composite stabilizer comprising a heat stabilizer and a lubricant, and 3 parts by weight of methyl methacrylate-butadiene-styrene (MBS), an impact modifier, were added to 100 parts by weight (5 kg) of the composite resin. After mixing at 105° C. for 20 minutes, a planar extrusion sample having a thickness of 3 mm was prepared using a HAAKE twin extruder. Processing was performed for less than 3 minutes along the die direction at a screw rotation rate of 30 rpm, while increasing the temperature to about 165, 170, 175 and 185° C. The resultant extrusion product was let to cool down. A Charpy impact strength sample and an Izod impact strength sample were prepared form the extrusion sample, according to Korean Industrial Standards (KS) B 5522 and KS M 3055, respectively. The impact strength measurement result is given in Table 1 below.

### EXAMPLE 2

A resin composition was prepared in the same manner of Example 1, except that 0.03 parts by weight of a polymerization initiator was further added to the stirring tank in the step (1) and that addition of the polymerization initiator was omitted in the step (2). The impact strength measurement result for the extrusion sample is given in Table 1.

### EXAMPLE 3

A resin composition was prepared in the same manner of Example 1, except that 4 parts by weight of a chlorinated polyethylene (CPE) was added to the PVC/nano calcium carbonate composite resin as impact modifier. The impact strength measurement result for the extrusion sample is given in Table 1.

### EXAMPLE 4

A resin composition was prepared in the same manner of Example 2, except that 4 parts by weight of a chlorinated polyethylene (CPE) was added to the PVC/nano calcium carbonate composite resin as impact modifier. The impact strength measurement result for the extrusion sample is given in Table 1.

### COMPARATIVE EXAMPLE 1

A resin composition was prepared in the same manner of Example 2, except that 6.5 parts by weight of an MBS impact modifier was added to 100 parts by weight (5 kg) of a polyvinyl resin not comprising nano calcium carbonate (LS100®, LG Chem). The impact strength measurement result for the extrusion sample is given in Table 1.

### COMPARATIVE EXAMPLE 2

A resin composition was prepared in the same manner of Example 2, except that 9 parts by weight of a CPE impact modifier was added to 100 parts by weight (5 kg) of a polyvinyl resin not comprising nano calcium carbonate (LS100®, LG Chem). The impact strength measurement result for the extrusion sample is given in Table 1.

TABLE 1

| | | | | | Comparative | Comparative |
|---|---|---|---|---|---|---|
| | Example | Example | Example | Example | Example | Example |
| Classification | 1 | 2 | 3 | 4 | 1 | 2 |
| Charpy impact | 88 | 89 | 48 | 48 | 30 | 28 |
| strength | | | | | | |
| (kg · cm/cm) | | | | | | |
| Izod impact | 114 | 113 | 106 | 104 | 15 | 14 |
| strength | | | | | | |
| (kg · cm/cm) | | | | | | |

As seen in Table 1, the nano calcium carbonate/vinyl chloride composite prepared by adding nano calcium carbonate shows significantly superior impact strength compared with the conventional vinyl chloride resin, even when the amount of the impact modifier is reduced to less than half. The Charpy impact strength was improved by almost three times when the content of MBS was reduced from 6.5 parts by weight (Comparative Example 1) to 3 parts by weight (Examples 1-2). It was also improved by 170% when the content of CPE was reduced from 9 parts by weight (Comparative Example 2) to 4 parts by weight (Examples 3-4). The Izod impact strength was also improved by at least 7 times when the amount of the impact modifier was reduced to less than half. Thus, the PVC/nano calcium carbonate composite of the present invention has significantly improved impact modification effect compared with the conventional vinyl chloride resin even with a small amount of impact modifier.

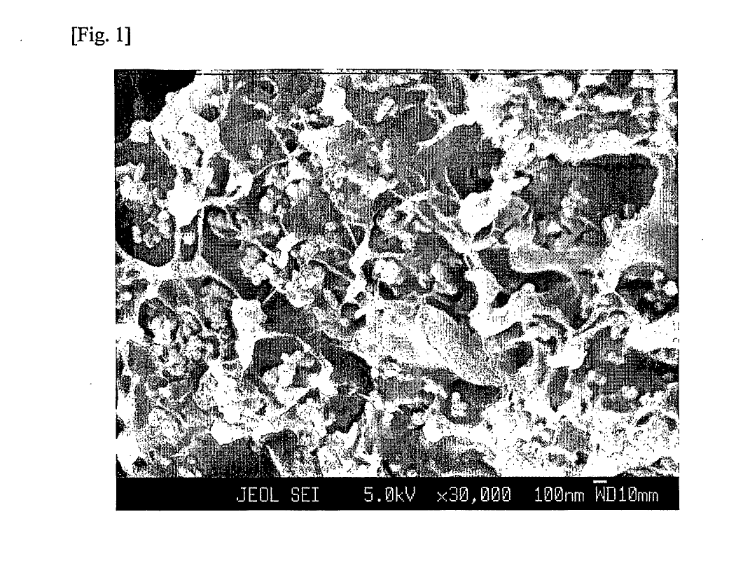

FIG. 1 is the scanning electron micrograph (SEM) of the cross-section of the PVC/nano calcium carbonate composite prepared in Example 1. As seen in FIG. 1, the nano calcium carbonate particles are uniformly distributed.

### INDUSTRIAL APPLICABILITY

As apparent from the above description, the PVC based nanocomposite resin composition and the method for preparing the same according to the present invention significantly improve the impact strength of a PVC resin by uniformly dispersing nano calcium carbonate in the PVC resin particles. According to the present invention, it is possible to reduce the amount of expensive impact modifier to about ⅕. Thus, the present invention is significantly effective in reducing production cost of a PVC resin requiring superior impact strength.

While the present invention described in detail with reference to the preferred embodiments, those skilled in the art will appreciate that various modifications and substitutions can be made thereto without departing from the spirit and scope of the present invention as set forth in the appended claims.

1. A nano calcium carbonate/vinyl chloride monomer dispersion comprising a vinyl chloride monomer, nano calcium carbonate and a lipophilic dispersing agent.

2. The nano calcium carbonate/vinyl chloride monomer dispersion of claim 1, which further comprises a polymerization initiator.

3. The nano calcium carbonate/vinyl chloride monomer dispersion of claim 1, which comprises 1-30 parts by weight of nano calcium carbonate and 0.01-10 parts by weight of a lipophilic dispersing agent per 100 parts by weight of the vinyl chloride monomer.

4. The nano calcium carbonate/vinyl chloride monomer dispersion of claim 2, which comprises 1-30 parts by weight of nano calcium carbonate, 0.01-10 parts by weight of a lipophilic dispersing agent and 0.01-5 parts by weight of a polymerization initiator per 100 parts by weight of the vinyl chloride monomer.

5. The nano calcium carbonate/vinyl chloride monomer dispersion of claim 1, wherein the lipophilic dispersing agent is a monomer or polymer compound having a molecular weight of 40-100,000, which includes a phosphoric acid, a carboxylic acid or a salt thereof.

6. The nano calcium carbonate/vinyl chloride monomer dispersion of claim 5, wherein the salts of the phosphoric acid or the carboxylic acid have an organic side chain selected from the group consisting of sodium, ammonium, primary, secondary, tertiary or quaternary alkyl ammonium salt, C₁-C₃₀ hydrocarbons, a homopolymer selected from the group consisting of polyolefin, polyether, polymethacrylate, polyacetate, polyacrylate, polyester and polyurethane, and a copolymer thereof.

7. The nano calcium carbonate/vinyl chloride monomer dispersion of claim 5, wherein the lipophilic polymer has a homopolymer selected from the group consisting of polyolefin, polyether, polymethacrylate, polyacrylate, polyacetate, polyester and polyurethane or a copolymer thereof as a main chain.

8. A PVC based nanocomposite resin composition prepared using the nano calcium carbonate/vinyl chloride monomer dispersion of claim 1.

9. A method for preparing a PVC based nanocomposite resin composition comprising the steps of:
(a) adding nano calcium carbonate and a lipophilic dispersing agent to a vinyl chloride monomer to disperse them;
(b) adding the resultant mixture system to an aqueous solution system comprising deionized water, a suspension stabilizer and a polymerization initiator to prepare a suspension system and polymerizing the suspension system at an elevated temperature to prepare a PVC based on a nocomposite resin composition; and
(c) processing the PVC based nanocomposite resin composition including an impact modifier to produce extruded articles.

10. The method of claim 9, wherein the impact modifier is at least one selected from the group consisting of a methyl methacrylate-butadiene-styrene copolymer, an acrylic impact modifier and chlorinated polyethylene.

11. The method of claim 9, wherein each of the nano calcium carbonate and the lipophilic dispersing agent in the step (a) is comprised in 1-30 parts by weight and 0.01-10 parts by weight, respectively, per 100 parts by weight of the vinyl chloride monomer and each of the suspension stabilizer and the polymerization initiator of the step (b) is comprised in 0.01-5 parts by weight and 0.01-5 parts by weight, respectively, per 100 parts by weight of the vinyl chloride monomer and the impact modifier of the step (c) is comprised in 1-10 parts by weight per 100 parts by weight of the PVC based nanocomposite resin composition.

12. The method of claim 9, wherein the nano calcium carbonate has a particle size of at most 500 nm.

13. The method of claim 9, wherein the lipophilic dispersing agent is a monomer or a polymer compound having a molecular weight of 40-100,000, which includes phosphoric acid, a carboxylic acid or salts thereof.

14. The method of claim 13, wherein the salts of the phosphoric acid or the carboxylic acid have an organic side chain selected from the group consisting of sodium, ammonium, a primary, secondary, tertiary or quaternary alkyl ammonium salt, C₁-C₃₀ hydrocarbon, a homopolymer selected from the group consisting of polyolefin, polyether, polymethacrylate, polyacrylate, polyacetate, polyester and polyurethane, and a copolymer thereof.

15. The method of claim 13, wherein the lipophilic polymer has a homopolymer selected from the group consisting of polyolefin, polyether, polymethacrylate, polyacrylate, polyacetate, polyester and polyurethane or a copolymer thereof as a main chain.

16. The method of claim 9, wherein the suspension stabilizer is at least one selected from the group consisting of vinyl acetate, cellulose and gelatin.

17. The method of claim 9, wherein the suspension stabilizer comprises: a primary suspension stabilizer comprising a polyvinyl acetate having a degree of polymerization of 500-3,000, which has been hydrolyzed to 70-98 mol %, and a modified cellulose having a degree of substitution of 1.0-3.0 and a degree of polymerization of 50-2,000; and a secondary suspension stabilizer comprising a polyvinyl acetate having a degree of polymerization of 500-3,000, which has been hydrolyzed to 10-60 mol %.

18. A method for preparing a PVC based nanocomposite resin composition comprising the steps of:
(a) adding nano calcium carbonate, a lipophilic dispersing agent and a polymerization initiator to a vinyl chloride monomer to disperse them;
(b) adding the resultant mixture system to an aqueous solution system comprising deionized water and a suspension stabilizer to prepare a suspension system and performing polymerization at an elevated temperature to prepare a PVC based nanocomposite resin composition; and
(c) processing the PVC based nanocomposite resin composition including an impact modifier to produce extruded articles.

19. The method of claim 18, wherein the impact modifier is at least one selected from the group consisting of a methyl methacrylate-butadiene-styrene copolymer, an acrylic impact modifier and a chlorinated polyethylene.

20. The method of claim 18, wherein each of the nano calcium carbonate, the lipophilic dispersing agent and the polymerization initiator of the step (a) is comprised in 1-30 parts by weight, 0.01-10 parts by weight and 0.01-5 parts by weight, respectively, per 100 parts by weight of the vinyl chloride monomer, the suspension stabilizer of the step (b) is comprised in 0.01-5 parts by weight per 100 parts by weight of the vinyl chloride monomer and the impact modifier of the step (c) is comprised in 1-10 parts by weight per 100 parts by weight of the PVC based nanocomposite resin composition.

21. The method of claim 18, wherein the nano calcium carbonate has a particle size of at most 500 nm.

22. The method of claim 18, wherein the lipophilic dispersing agent is a monomer or polymer compound having a molecular weight of 40-100,000, which includes a phosphoric acid, a carboxylic acid or a salt thereof.

23. The method of claim 22, wherein the salts of the phosphoric acid or the carboxylic acid have an organic side chain selected from the group consisting of sodium, ammonium, a primary, secondary, tertiary or quaternary alkyl ammonium salt, C₁-C₃₀ hydrocarbon, a homopolymer selected from the group consisting of polyolefin, polyether, polymethacrylate, polyacrylate, polyacetate, polyester and polyurethane, and a copolymer thereof.

24. The method of claim 22, wherein the lipophilic polymer has a homopolymer selected from the group consisting of polyolefin, polyether, polymethacrylate, polyacrylate, polyacetate, polyester and polyurethane or a copolymer thereof as a main chain.

25. The method of claim 18, wherein the suspension stabilizer is at least one selected from the group consisting of vinyl acetate, cellulose and gelatin.

26. The method of claim 18, wherein the suspension stabilizer comprises: a primary suspension stabilizer comprising a polyvinyl acetate having a degree of polymerization of 500-3,000 and a modified cellulose having a degree of substitution of 1.0-3.0 and a degree of polymerization of 50-2,000, which has been hydrolyzed to 70-98 mol %; a secondary suspension stabilizer comprising a polyvinyl acetate having a degree of polymerization of 500-3,000, which has been hydrolyzed to 10-60 mol %.
